(19) United States
(12) Patent Application Publication
(10) Pub. No.: US 2009/0308244 A1
(43) Pub. Date: Dec. 17, 2009

(54) Method and Equipment for Filtering Air in an Urban Environment

(75) Inventors: Angelo Brichese, Noventa Padovana (IT); Ermanno Faggin, Villa di Teolo (IT); Erik Faggin, Villa di Teolo (IT)

Correspondence Address: Themis Law, 7660 Fay Ave Ste H-535, La Jolla, CA, 92037, US

(73) Assignee: MIX PROGETTI S.R.L., Noventa Padovana (PD) (IT)

(21) Appl. No.: 12/524,886

(22) PCT Filed: Feb. 19, 2007
(86) PCT No.: PCT/IT2007/000113

§ 371 Date: Aug. 8, 2009

(51) Int. Cl. B01D 50/00; B01D 46/42; B01D 46/46; B01D 46/48; B01D 46/04; B03C 3/00

(52) U.S. Cl. 95/20; 95/278; 95/26; 95/23; 95/1; 55/431; 55/302; 55/283; 96/417; 96/142; 96/57; 96/414; 96/380

(57) ABSTRACT

The invention relates to a method with associated device for the removal of fine particulates from the air in open areas and includes the phases of suction intake, filtering and re-emission into the atmosphere of the air taken from the environment at a height near the ground. The device also provides for the cleaning of the filtering equipment and for the discharge of the washing sludge for subsequent disposal.

### FIELD OF THE INVENTION

The present invention relates to methods for treating air, and in particular relates to a new method for treating and eliminating fine particulates and other contaminants from the air, particularly in open urban areas, and the equipment or filtering station implementing said method.

### BACKGROUND OF THE INVENTION

Today the problem of high concentrations of contaminants in the atmosphere is particularly felt. Due to their quantities, persistence and chemical-physical characteristics, said contaminants are considered harmful for humans, animals and plants, and also affect numerous other environmental aspects.

In particular, atmospheric pollution due to the high concentration in the atmosphere of particle material or particulate, i.e. mixtures of solid or liquid particles suspended in the air, having a characteristic diameter equal to or below 10 gm and commonly defined PM10, is known.

The particulates having a characteristic diameter equal to or below 2.5 μm are defined PM2.5.

The origins of the emissions of PM10 or PM2.5 are natural, such as erosion of the soil, diffusion of pollen and spores, or anthropic.

In particular, in urban areas, said substances are mainly generated by combustion engines, heating systems, industrial emissions and wear of the road surface by traffic.

PM10 and above all PM2.5 are extremely dangerous for humans; they cause irritations and inflammations and also more serious and chronic pathologies. In fact, fine particulates are easily inhaled, penetrate into the respiratory system at various levels, where they remain for very long periods, and also contain very harmful micropollutants, acid substances and toxic or carcinogenic chemical substances, like heavy metals and aromatic polycyclic hydrocarbons.

PM10 also causes alterations in the physical properties of the atmosphere, such as visibility, reflection and refraction of light, affects the quality and type of radiation that reaches the earth, and favors the formation of mist and clouds and the occurrence of acid rain.

The massive presence of particulate in urban areas also causes blackening of the outer walls of buildings and monuments.

Various methods and devices for air treatment are known, designed to reduce the contaminating agents in general and fine particulates in particular.

Methods and devices are known that are suitable for purifying and removing dust from air in environments that are closed or located immediately downstream of the source of contaminants, and are also suitable for limiting the diffusion thereof.

For example, the adoption of filters suitable for reducing the contaminating agents produced by heating systems is known.

Filters for air conditioning systems are also known which remove dust, pollen and other small particles from the air coming into the environment to be conditioned.

Currently, however, no effective devices exist for elimination of the fine particulates produced by motor vehicles. For this reason, particularly in urban areas and in the vicinity of congested roads, the concentration of PM10 reaches very high values, even well beyond the limit values considered dangerous for human health.

The particulates produced by traffic are emitted at low level, i.e. at a height substantially between 0 and 100 cm from the ground, and axe then transported into the surrounding area by wind and air movements.

### SUMMARY OF THE INVENTION

The subject of the present invention is a new method for eliminating the fine particulates and other contaminants from the air, particularly in open urban areas, and the filtering equipment implementing said method.

The object of the new method and of the filtering station is to remove the contaminating load of PM10 from the air withdrawn in the vicinity of the main areas of generation and emission of the fine particulates.

A further object is to collect the particles and the fine particulates removed from the air so as to dispose of them in an appropriate manner.

A further object is to eliminate also the smells, significantly improving the quality of the air.

One of the advantages of the new method and of the filtering station is represented by the fact that they make it possible to treat and remove the dust from the air in open environments, where the concentration of particulates is higher, therefore limiting the diffusion thereof in the surrounding environment. A further important advantage consists in the fact that the invention has reduced overall dimensions, comparable for example to those of a motor vehicle.

These and other direct and complementary objects are achieved by the new method for removal of the fine particulates from the air in open areas, comprising the following phases:

suction intake of the contaminated air, withdrawn from the environment at a height generically between 0 and 100 cm from the ground;

reduction of the particles and fine particulates by treatment of the air taken in;

emission into the atmosphere of the cleaned air at a point generically higher than one meter or in any case substantially higher than the air intake area;

cleaning and washing of the filtering devices used; and

collection and discharge of the washing sludge.

The new air treatment method provides firstly for the withdrawal of the air from a point near the ground, where the emissions of particles and fine particulates are most concentrated, i.e. at a height generically not exceeding 100 cm from the ground.

The air withdrawn is then filtered and treated in order to remove the particles and fine particulates from the air flow.

The filtered treated air is re-emitted into the atmosphere at a point higher than the point from which it was withdrawn, for example at a point higher than one metre from the ground.

The particles and fine particulates accumulate on the filters, which are regularly cleaned by blow-in of air under back pressure and washing of the dust collecting hoppers. The sludge obtained from the washing of said hoppers, loaded with the contaminating substances that have detached from the walls of the filters in the cleaning phase, is discharged into containers and then conveyed to the subsequent disposal process.

Said new method is conveniently implemented via the use of one or more specific pieces of equipment, hereinafter called filtering stations, located in external environments and open areas, each comprising:

at least one air suction intake device with inlets located at an appropriate height with respect to the ground, for example less than 100 cm;

one or more pieces of equipment for filtering the contaminated air taken into the filtering station;

one or more diffusers for emission of the filtered air into the atmosphere, positioned above the intake point, for example at a height of 100 cm;

devices for cleaning said air filtering and treatment equipment, by blow-in of air under back pressure;

one or more dust collection hoppers;

one or more devices for washing the dust collection hoppers;

one or more devices for discharging and collecting the washing sludge.

### BRIEF DESCRIPTION OF THE DRAWINGS

The characteristics of the new method and the new filtering station for removal of fine particulates from the air in open areas will be better clarified in the following description with reference to the drawings, attached as a non-limiting example.

FIG. 1 shows, by way of non-limiting example, a possible embodiment of the filtering station comprising, in addition to filters (3.1) and filtering cartridges (3.2) for the coarse and fine fractions, also activated carbon filters (3.3) for elimination of the smells.

FIGS. 2, 3, 4, 5 schematize some of the fundamental components of the new filtering station in the preferred embodiment, shown respectively in lateral view, overhead view and in two three-dimensional views.

FIG. 6 shows a three-dimensional view of the outside of the station, while FIG. 7 shows the details of the device (D) for display of the filtering efficiency of the station.

### DETAILED DESCRIPTION OF THE INVENTION

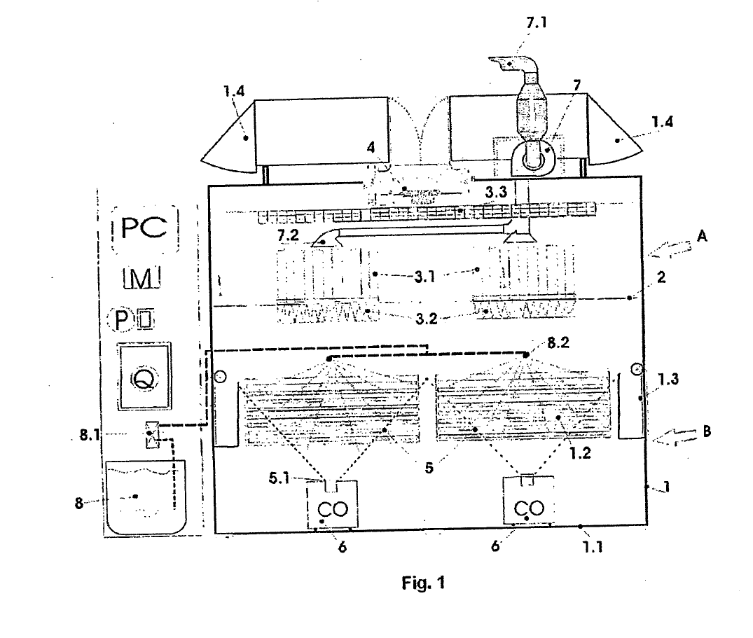

Referring to FIG. 1, a filtering station constructed according to the principles of the invention comprises a machine body or cabinet (1) with supporting base (1.1), air suction inlets (1.2) and powered shutters (1.3) suitable for opening/closing said air suction inlets (1.2).

Said inlets (1.2) are positioned at a height of between approximately 0 and 100 centimeters from the ground or in any case at the height considered most suitable for the intake of air with the greatest concentration of PM 10 and contaminating particles.

Inside said machine body (1) there is at least one partition or wall (2), positioned above said inlets (1.2), suitable for dividing the inner space substantially into at least one upper volume (A) and at least one lower volume (B).

Said partition or wall (2) has one or more apertures suitable for providing a connection between said two volumes (A, B) inside the machine body (1); at the level of said apertures, suitable filtering equipment is conveniently positioned and fixed for retaining the particles larger than one tenth of a micron transported by the flow of air sucked in.

In particular, for example, the use of a battery of filtering cartridges (3.1) positioned above said partition (2) is envisaged, as well as the use of one or more filters (3.2) for the flow of contaminated air, positioned upstream of said cartridges (3.1), suitable for retaining the coarsest particles.

In detail, the new filtering station will comprise a first filtering stage for the coarse fraction, for example by means of fabric filters (3.2) with suitably sized mesh.

Said filters (3.2) can, for example, be installed on guides or rails so that they can be rapidly removed or replaced.

The second filtering stage for the fine fractions, up to 0.2 is performed for example by means of a battery of cartridges (3.1) in non-woven polyester with dense mesh. Said cartridges (3.1) are preferably positioned vertically to maximize the filtering surface and the stay time and, in addition, to facilitate detachment of the particulates in the subsequent backwashing phase.

Said cartridges (3.1) are highly efficient in terms of elimination of the fine particulates, up to 0.2 μm, and high mechanical, thermal and chemical resistance.

In the upper part of said machine body (1) there is at least one extractor (4) suitable for generating a flow of air, which is taken in from the outside via said inlets (1.2), and where said flow of contaminated air is conveyed through said filtering cartridges (3.1) and then re-emitted into the atmosphere via one or more diffusers (1.4) located in the upper part of the machine body (1) which diffuse the treated air upwards and/or laterally.

According to the invention, the new filtering station can therefore also comprise elements for deflecting the flow of air, which are suitable for conveying the flow towards said diffusers (1.4).

The particles, fine particulates and other contaminants retained by the filtering cartridges (3.1) adhere to the walls of the cartridges (3.1) or drop down into discharge hoppers (5) below, communicating with collecting containers (6) and provided with lower opening/closing shutters (5.1).

In the suction intake phase, said extractor (4) operates and said powered shutters (1.3) of said suction inlets (1.2) are open, thus allowing contaminated air into the filtering station.

The accumulation of particles and dust on said cartridges (3.1) causes a gradual increase in pressure loss and it is therefore necessary to periodically perform cleaning and washing of said cartridges (3.1) by means of the devices described and claimed below.

In the solution shown in FIG. 1, the new filtering station also comprises at least one back pressure fan (7) which sucks the air in from the outside (7.1), at a point generally higher than the level at which the greatest concentration of PM10 is found, therefore higher than 100-150 cm, and which generates a flow of air under back pressure, conveying it onto said filtering cartridges (3.1) by means of diffusers (7.2).

In the backwashing phase, said extractor (4) is stopped, the powered shutters (1.3) of the suction inlets (1.2) are closed to prevent outflow of the dust and the back pressure fan (7) is activated.

Said extractor (4) maintains the function of discharging any overpressure generated in the machine body during operation of the pressure fan (7).

The dust and particles adhering to the filters of the cartridges (3.1) are then detached from the filters, which are hit by said back pressure flow, and fall down into said hoppers (5) where they are collected.

The discharge shutter (5.1) of each of said hoppers (5) is closed, so that the particulates accumulate in the hopper (5).

The new filtering station also comprises a tank (8) for the washing water which is taken in by means of a pump (8.1) and then atomized or sprayed above said hoppers (5) during said backwashing phase.

The sludge produced in this phase and collected in said hopper (5) is finally discharged, during the subsequent discharge phase, into watertight containers below (6).

During said discharge phase, both said extractor (4) and said back pressure fan (7) are de-activated, the shutters (1.3) of the inlets (1.2) and the back pressure diffusers (7.2) are closed, the washing water pump (8.1) is de-activated and the washing water atomizer nozzles (8.2) are closed, whereas said shutters (5.1) of the hoppers (5) are opened so that the washing sludge is discharged into the watertight containers (6) below and subsequently disposed of.

Furthermore, according to the invention the new filtering station will comprise one or more devices for controlling the speed and/or the pressure of the air flow circulating in the station in order to determine the right moment for cleaning the cartridges (3.1).

For said purpose, the new station will also comprise for example one or more differential pressure gauges (P) which will be operated at least during the suction phase and are suitable for measuring the level of clogging of the cartridges (3.1).

Said new filtering station can also comprise one or more further filtering stages that are performed upstream of said extractor (4) and downstream of said filtering cartridges (3.1).

In particular, one or more activated carbon filters (3.3) can be used, having the function of deodorizing the outflowing air and further reducing the contaminating load, intercepting the aerosol and the smallest particles, for example of hydrocarbons, inorganic compounds or compounds of fumes.

Given their large specific internal surface, between 500 and 1500 m2/g, the activated carbon filters (3.3) have high efficiency in terms of adsorption of many chemical substances.

Alternatively or together with the use of said activated carbon filters (3.3), it is possible to provide for a further filtering stage with electrostatic filter (3.4), which guarantees a filtering efficiency of corpuscles and aerosol above 99%, also of particles with characteristic diameter below 0.01 μm or of corrosive substances.

Further advantages deriving from use of the electrostatic filter are the low pressure losses, long life and the possibility of working at high operating temperatures.

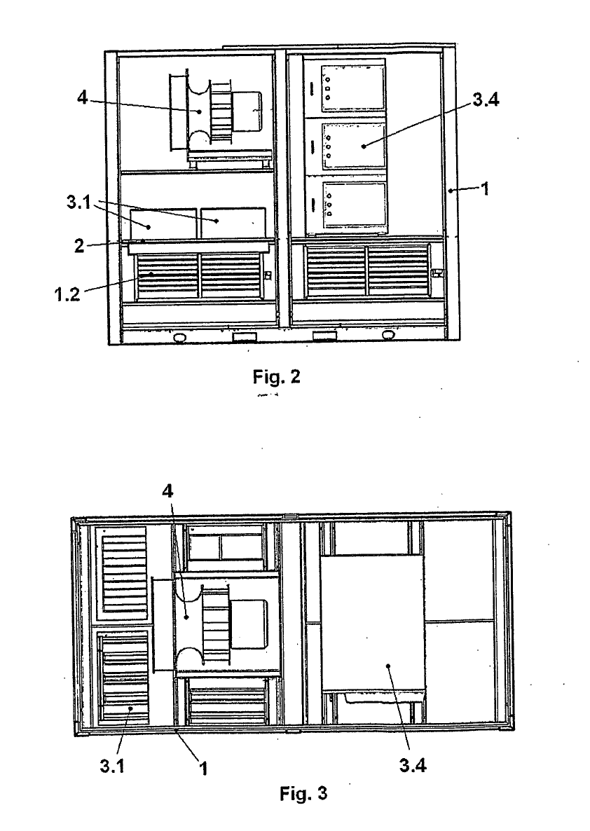

In particular, in the preferred embodiment of the invention, shown in FIGS. 2, 3, 4, 5, schemitized in its main components for greater graphic clarity, the new station will comprise one single fan (4), positioned above said filtering cartridges (3.1), suitable for generating a flow of air taken in from the outside through said inlets (1.2) and conveyed through said filters (3.2) and said cartridges (3.1).

Said fan (4) directs the flow of filtered air coming out of said cartridges (3.1) in a substantially horizontal direction, towards electrostatic filters (3A) positioned in front of the fan (4).

The air treated by said electrostatic filters (3.4) is then emitted to the outside by means of apertures located in the upper part of the container body (1), not shown in the figure.

In the backwashing phase, said suction inlets (1.2) are closed and said fan (4) inverts the flow of air, which is thus directed under back pressure into said filtering cartridges (3.1), causing detachment of the dust and impurities deposited on them.

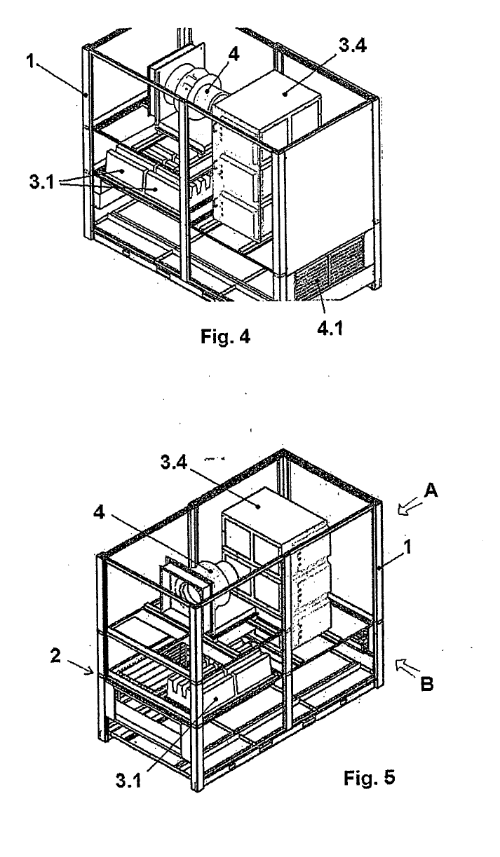

To discharge any overpressure, at least one further outlet (4.1) will be opened (FIG. 4).

Analogously to what has been previously described, the particulates and particles that have detached from the walls of the filtering cartridges (3.1) fall down into collecting hoppers (not shown in FIGS. 2, 3, 4, 5).

The washing water taken from the collection tank is atomised or sprayed above said hoppers and the sludge produced is then discharged, during the subsequent discharge phase, into watertight containers below.

During said discharge phase, said extractor (4) is de-activated and said suction inlets (1.2) are closed, furthermore the washing water pump is de-activated and the washing water atomizer nozzles are closed whereas the hopper shutters are opened, so that the washing sludge is discharged into the watertight containers below and is subsequently disposed of.

Operation of the new filtering station will be controlled by means of electronic equipment and devices, such as personal computers and control panels (PC, Q), contained in a lateral cabinet (1.5) shown in FIG. 1 but not shown in FIGS. 2-5 for the sake of graphic simplicity.

According to the invention, said equipment can also be remote-controlled or controlled in a network by means of modem (M) so that it is possible to control correct operation of the station by monitoring functions and parameters, while routine maintenance operations can be programmed and extraordinary maintenance operations can be promptly carried out.

On the side walls of the machine body (1) there are panels for inspection of the inside of the machine body, allowing the operators to access the internal parts of the filtering station for maintenance and cleaning operations.

The new filtering station also comprises a device for the display of the purification efficiency of the station.

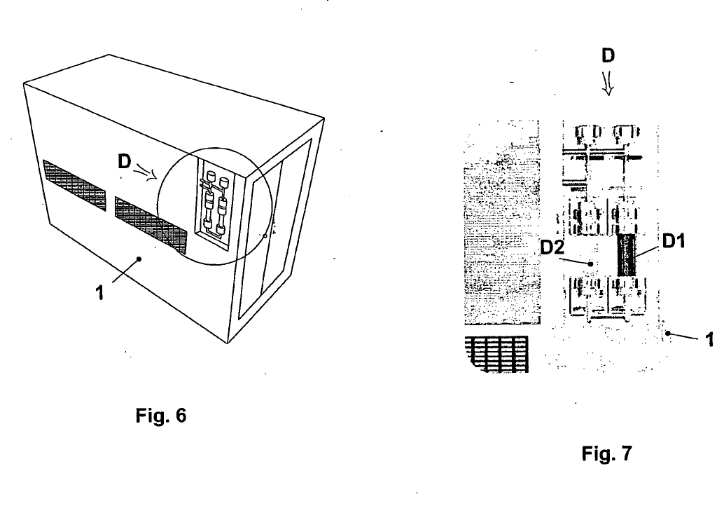

Referring now to FIGS. 6 and 7, the device (D) comprises, for example, at least two ducts, cartridges or filters (D1, D2), into which part of the flow of contaminated air taken in from the outside and part of the flow of filtered air, before re-emission into the atmosphere, are conveyed.

The duct or cartridge (D1) through which part of the flow of contaminated air not yet treated is conveyed will become progressively loaded with the impurities and dust contained in it, gradually blackening.

The duct or cartridge (D2) through which part of the flow of treated air is conveyed before emission into the atmosphere remains clean, since the impurities previously contained in the air have already been removed in the preceding treatment phases.

Said ducts are transparent and said cartridges or filters (D1, D2) are preferably contained in transparent casings and positioned outside the filtering station or are in any case visible from the outside. In this way the station filtering efficiency can be immediately seen, and also the non-expert passer-by or observer can visually assess the quality of the air re-emitted into the atmosphere after the treatment, comparing it with the quality of the non-treated contaminated air.

The new station furthermore comprises dissipation silencers and/or soundproofing boxes for the moving mechanical equipment, in such a way as to reduce the acoustic impact in compliance with the current laws.

Therefore, with reference to the preceding description, and the attached drawings, the following claims are made.

What is claimed is:

1. A method of removing fine particulates from air in urban areas comprising:
taking in contaminated air by suction, the air being taken from a urban environment at a height near the ground;
filtering and/or treating the air taken in to reduce particle and fine particulate load;
emitting treated air into the atmosphere, the treated air being free from dust at a point substantially higher than a point at which the contaminated air was taken in; and
cleaning and washing of filtering equipment used for treating the contaminated air;
wherein the step of cleaning and washing is performed alternatively to the steps of taking in, filtering and/or treating, and emitting.

2. The method according to claim 1, further comprising the step of discharging washing sludge derived from the cleaning and washing of the filtering equipment, wherein the discharging step is performed alternatively to the steps of taking in, filtering and/or treating, and emitting.

3. The method of claim 1, wherein the steps of taking in, filtering and/or treating, emitting, and cleaning and washing are activated alternatively in the listed order, in automatic cyclic mode and/or according to detected parameters of power absorbed by one or more of suction devices, pressure, or speed of an air flow to be treated.

4. Air treatment equipment configured to perform the method of claim 1 the air treatment equipment comprising:
at least one fan or suction device configured to intake contaminated air via one or more suction inlets positioned at a height near the ground;
one or more pieces of equipment configured for filtering and treating the contaminated air taken in;
one or more apertures and/or diffusers for emitting the filtered air into the atmosphere at a point higher than an intake point;
one or more hoppers for collecting filtered dust and particles detached from filters of the filtering equipment and washing water;
one or more devices for washing said hoppers with water;
one or more containers for collecting washing sludge from said hoppers,
wherein one or more powered shutters are configured to open said suction inlets permitting an introduction of the contaminated air, or close said suction inlets, preventing entry and exit of air or dust, the fan or suction device being configured to invert motion and provide a back pressure when the suction inlets are closed.

5. The air treatment equipment according to claim 4, further comprising an additional fan having related intakes and diffusers, the additional fan being suitable for generating, a flow of air under back pressure on said filtering equipment when the filters are washed.

6. The air treatment equipment according to claim 5, further comprising one or more devices for measuring power absorbed by said filtering equipment, and/or one or more pressure gauges for measuring pressure and/or speed of a flow of the contaminated air taken in, wherein an identification of certain values of the power absorbed and/or the pressure and/or the speed determines interruption of an air treatment phase and implementation of a cleaning and washing phase of the filters.

7. The air treatment equipment according to claim 5 further comprising at least one electronic device for identification and control of a time interval between consecutive cleaning and washing cycles, the electronic device being suitable for communicating any time intervals detected below certain values to one or more control units by means of via alarm signals and/or a modern, thereby providing an indication of a need for replacement and/or maintenance of the filtering equipment.

8. The air treatment equipment according to claim 5 further comprising a machine body provided internally with a partition or wall suitable for dividing an internal volume of the air treating equipment into a lower volume, into which the contaminated air is introduced via said suction inlets, and an upper volume communicating with an outside environment via said apertures and/or diffusers for re-emitting the filtered air into the atmosphere, wherein said partition or wall has one or more apertures suited to provide communication between said upper and lower volumes, at least some of the filtering equipment being positioned at each aperture.

9. The air treatment equipment according to claim 8, wherein the filtering equipment comprises one or more fabric filters having a mesh sized for a first filtering stage of a coarse fraction, ad wherein said fabric filters are positioned upstream of one or more batteries of fabric filtering cartridges having a dense mesh for a second filtering stage of a fine fraction.

10. The air treatment equipment according to claim 5, wherein the filtering equipment comprises one or more activated carbon filters positioned downstream of one or more batteries of filtering cartridges and upstream of said fan or suction device, the activated carbon filters being suitable for further treating outflowing air.

11. The air treatment equipment according to claim 5, wherein the filtering equipment comprises at least one electrostatic filter positioned downstream of one or more batteries of filtering cartridges and suitable for further treating a flow of air directed toward the electrostatic filter by said fan or suction device.

12. The air treatment equipment according to claim 4, wherein said suction inlets are positioned no higher than 100 cm from the ground.

13. The air treatment equipment according to claim 4, wherein said apertures or diffusers for emission of the filtered air into the atmosphere are positioned at a minimum height of 100 cm from the ground.

14. The air treatment equipment according to claim 9, further comprising at least one tank from which, during a cleaning and washing phase of the air treatment equipment, washing water is drawn and subsequently atomized or sprayed into said machine body below said filtering cartridges with nozzles, in order to convey and collect the dust and particles that have detached from the filtering cartridges into said collecting hoppers.

15. The air treatment equipment according to claim 14, further comprising at least one pump for moving the washing water.

16. The air treatment equipment according to claim 4, wherein said hoppers are provided with shutters for opening or closing a lower discharge outlet of said hoppers, and wherein said hopper shutters are closed during an air treatment phase and during a cleaning and washing phase of the air treatment equipment, and are open during a discharge phase after the cleaning and washing phase, to allow the washing sludge to fall down and be collected into said lower containers.

17. The air treatment equipment according to claim 4, further comprising electronic devices for command and control of Operating phases of the air treatment equipment.

18. The air treatment equipment according to claim 4, further comprising at least one device for display of purification efficiency of the air treatment equipment, said device comprising in turn at least two transparent ducts, cartridges or filters, into which part of a flow of the non-treated contaminated air and part of a flow of treated air are respectively conveyed, wherein said ducts, cartridges or filters are contained in transparent casings visible from outside of the station.

19. The air treatment equipment according to the claim 4, further comprising one or more inspection panels for access to internal parts.

20. The air treatment equipment according to claim 4, further comprising one or more of a silencer device or soundproofing box for said suction device, fan, or other moving mechanical parts.
